(19) United States
(12) Patent Application Publication
(10) Pub. No.: US 2007/0130510 A1
(43) Pub. Date: Jun. 7, 2007

(54) Method and apparatus for improving user accessibility on the web

(76) Inventors: Gautam Dharamshi, Mountain View, CA (US); Franz-Dieter Berger, Kleinblitterdorf (DE)

Correspondence Address: RICHARD F. JAWORSKI;Cooper & Dunham LLP, 1185 Avenue of the Americas, New York, NY, 10036, US

(21) Appl. No.: 11/296,545

(22) Filed: Dec. 7, 2005

(51) Int. Cl. G06F 17/00

(52) U.S. Cl. 715/513; 715/760

(57) ABSTRACT

A method of coding a Web page for improving accessibility for a disabled user using assistive technology to read the Web page, includes coding a first element on a Web page and modifying the first element to include at least one coding block in a language not effected by a scripting control setting on a browser used to display the Web page and configured to skip the first element responsive to receiving a skip request from the disabled user.

### BACKGROUND

1. Technical Field

The present disclosure relates generally to the Web and, more particularly, to a method and apparatus for improving user accessibility on the Web.

2. Description of the Related Art

Non-disabled users of Web-based information and applications may take for granted the ease with which they are able to navigate the Web. For example, non-disabled users can quickly scan a Web page and, without reading any words on the page, determine the area having the “main content,” areas having links to other stories, etc. For users having vision problems, this is not always easily accomplished. For example, blind users often rely on some form of assistive technology such as a screen reader or talking browser to browse a Web page. Depending on the structure and amount of content on a Web page, finding a particular area of the Web page can be difficult and frustrating for vision impaired users.

Screen readers and talking browsers, referred to as assistive technologies, use a linearizing technique to convert a Web page to a sequence of words and lines. Assistive technologies convert images to their alternative text and then spread out or linearize tables a cell at a time, working from left to right across each row. Web developers often place a number of navigational links across the top, bottom and/or side of a Web page. Disabled users utilizing assistive technology are often faced with the tedious chore of having to wait for the assistive technology to work through and announce each of the navigational links before getting to the user's intended location on the Web page. Portions of the Web page which the user desires to hear such as, for example, the “main content” may be the last to be heard when using one of the conventional assistive technologies. Accordingly, vision impaired users may be forced to listen to all of the less important items on the Web page before hearing the main content.

U.S. Section 508 of the Rehabilitation Act provides strict guidelines when Federal agencies develop, procure, maintain and use electronic and information technology. Section 508 is designed to ensure that the technology being used by Federal agencies allow Federal employees with disabilities, to the extent possible, to have access to and use of information and data comparable to that by Federal employees who do not have disabilities. In addition, Section 508 is designed to allow disabled individuals seeking information or services from a Federal agency, to have access to and use of information and data that is comparable to that provided to individuals without disabilities.

A Compliance Board was charged with developing technical and functional provisions to establish a minimum level of accessibility required under Section 508. The technology-specific provisions addressed, among other things, include Web-based information and applications.

Section 1194.22, entitled “Web-based intranet and internet information and applications,” lists a set of standards that are to be adhered to when Federal agencies procure, develop, maintain or use Web-based information and applications. These standards include specifying that a method be provided that permits users to skip repetitive navigation links. Accordingly, Web pages often have a visible or invisible “Skip Navigational Links” button at the top of the page which allows disabled users to skip directly to the main content if they so desire. However, disabled users may still be faced with the chore of having to wait while their assistive technology device works through and announces other elements of the Web page, particularly if the user has disabled the use of Javascript on their browser.

### SUMMARY

In a first aspect a method of coding a Web page for improving accessibility for a disabled user using assistive technology to read the Web page is provided. The method includes coding a first element on a Web page and modifying the first element to include at least one coding block in a language not effected by a scripting control setting on a browser used to display the Web page and configured to skip the first element responsive to receiving a skip request from the disabled user.

In another aspect, a system of providing a Web page with improved accessibility for a disabled user using assistive technology to read the web page is provided. The system includes preparing code describing the Web page, the code including code for displaying a first element of the Web page and code modifying the first element to include at least one coding block in a language not effected by a scripting control setting on a browser used to display the web page and configured to skip the first element responsive to receiving a skip request from the disabled user. The system makes the code describing the Web page available to users.

In a further aspect, a computer recording medium including computer executable code for improving accessibility for a disabled user using assistive technology to read a Web page is provided. The computer recording medium includes code for displaying a first element on a Web page and code modifying the first element to include at least one coding block in a language not effected by a scripting control setting on a browser used to display the Web page and configured to skip the first element responsive to receiving a skip request from the disabled user.

In yet another aspect, a computer data signal transmitted in one or more segments in a transmission medium which embodies code for displaying a Web page on a computer, the Web page for improving accessibility for a disabled user using assistive technology to read the Web page is provided. The computer data signal includes code for displaying a first element on a Web page and code modifying the first element to include at least one coding block in a language not effected by a scripting control setting on a browser used to display the Web page and configured to skip the first element responsive to receiving a skip request from the disabled user.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows a block diagram of an exemplary computer system capable of implementing the method and system of the present disclosure;

FIG. 2 shows an example of a groupbox which may be provided on a Web page and, using an embodiment of the present disclosure, may be skipped by a user utilizing assistive technology;

FIG. 3 shows an example, of a tab control which may be provided on a Web page and, using an embodiment of the present disclosure, may be skipped by a user utilizing assistive technology;

FIG. 4 shows an example of a tree control which may be provided on a Web page and, using an embodiment of the present disclosure, may be skipped by a user utilizing assistive technology;

FIG. 5 shows an example of a data table which may be provided on a Web page and, using an embodiment of the present disclosure, may be skipped by a user utilizing assistive technology;

FIG. 6 shows examples of buttons which may be provided on a Web page and, using an embodiment of the present disclosure, may be skipped by a user utilizing assistive technology;

FIG. 7 is a flow chart for describing overall embodiments of the present disclosure; and

FIG. 8 is a flow chart for further describing a step in the flow chart of FIG. 7 according to an embodiment of the present disclosure.

### DETAILED DESCRIPTION

The following exemplary embodiments are set forth to aid in an understanding of the subject matter of this disclosure, but are not intended, and may not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

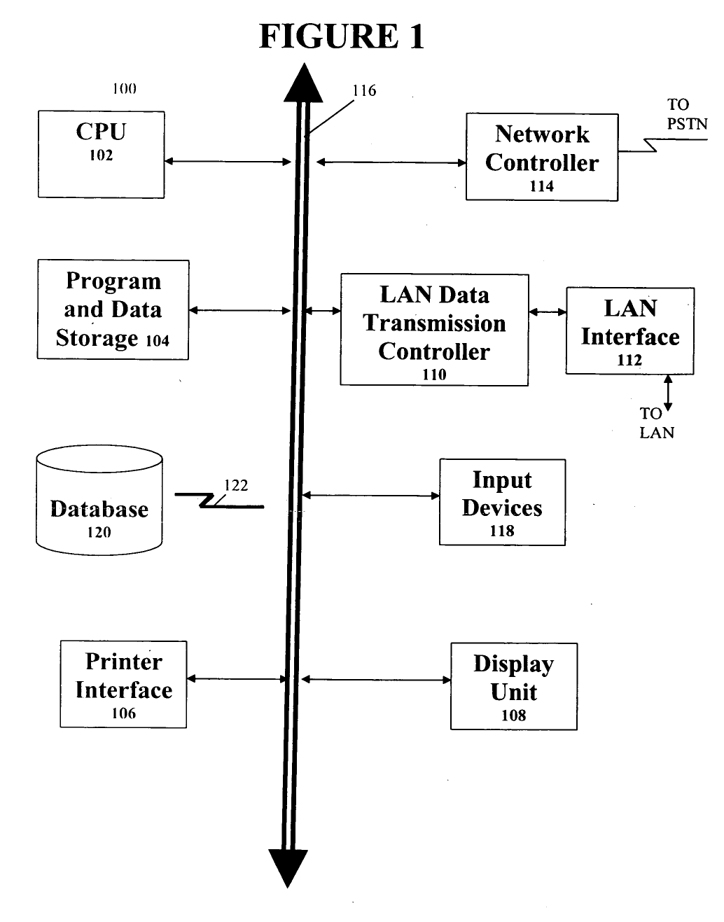

FIG. 1 shows an example of a computer system 100 which may implement the method and system of the present disclosure. Embodiments of the present disclosure may be implemented in the form of a software application running on a computer system, for example, a mainframe, personal computer (PC), handheld computer, server, etc. The software application may be stored on a recording media locally accessible by the computer system, for example, floppy disk, compact disk, hard disk, etc., or may be remote from the computer system and accessible via a hard wired or wireless connection to a network, for example, a local area network, or the Internet. The functionality of the software application may also be implemented in one or more services or components that are being executed in an application server or other run-time environment.

The computer system 100 can include a central processing unit (CPU) 102, program and data storage devices 104, a printer interface 106, a display unit 108, a (LAN) local area network data transmission controller 110, a LAN interface 112, a network controller 114, an internal bus 116, and one or more input devices 118 (for example, a keyboard, mouse etc.). As shown, the system 100 may be connected to a database 120, via a link 122.

The computer system 100 is merely exemplary, and one skilled in the art will appreciated that many variations can be made in the structure or function of the computer system 100. The specific embodiments described herein are illustrative, computer system(s) as referred to herein may include(s) individual computers, servers, computing resources, networks, etc.

The present system can be implemented in digital electronic circuitry, or in computer hardware, firmware, software, or in combinations of them. The system can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program or software application can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with the present system can be performed by one or more programmable processors executing a computer program to perform functions of the invention by operating on input data and generating output. Method steps can also be performed by, and apparatus of the disclosure can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROMs (Compact Disc Read-only Memory) and DVD-ROMs (Digital Versatile Disc Read-only Memory). The processor and the memory can be supplemented by, or incorporated in special purpose logic circuitry.

A Web page is a collection of information which generally includes one or more Web resources intended to be rendered simultaneously and may be identified by a single URI (Uniform Resource Identifier). The Web page may include dynamically generated content not identified by a URI. Generally, the contents of a Web page are coded in a mark-up language. Examples of mark-up languages include HTML, XHTML, etc. Although the various embodiments are described herein as utilizing HTML, it will be appreciated that other mark-up languages and/or tag libraries may also be used.

Web pages often contain one or more and often many different types of elements. For example, Web pages may contain groupboxes, tab controls, tree controls, data table views, push buttons, etc. For vision impaired users, such Web pages can be difficult to navigate when using one of the available assistive technologies. Vision impaired users are often forced to listen as the assistive technology device works through and announces the different elements on the Web page until they come to the content they specifically desire. This can be very time consuming and frustrating for these users.

One way this problem can be ameliorated is by the use of Javascript coding which allows a user to skip over elements of a Web page if desired.

A script is a client side program that may accompany an HTML document or be embedded directly in it. The script executes on the client's machine when the document loads or when a link to the script is activated. Javascript is an example of a scripting language. Javascript is an example of a simple programming language that can be embedded in HTML. Javascript allows more control over a Web page than HTML alone does. Javascript can be used to create dynamic, creative and interactive Web pages. For example, Javascript can be used to validate form input, create image rollovers, open pop-up windows, etc. However, since Javascript is interpreted and executed by the Web client, it can be abused by hackers, etc. That is, Javascript, like some other programming languages, can open serious security loopholes, allowing third parties to obtain personal information, etc. from a user's computer system. Most Web browsers allow users to customize their systems to enable/disable software including Javascript. Users will often disable Javascript on their Web browsers in order to provide a more secure session. However, when Javascript is disabled on a browser, vision impaired users conventionally lose the advantage of being able to skip over large elements in a Web page that would otherwise be possible if Javascript were enabled.

Embodiments of the present disclosure allow a disabled user to skip over elements on a Web page even while Javascript is disabled. Embodiments of the present disclosure also have the advantage that the movements are recorded as part on the browser history, so that browser features allowing users to move backward and forward can be utilized by default to go to the beginning and the end of an element.

As will be shown in more detail below, coding blocks are added before and after the code for the element to be skipped. The coding block before the code for the element to be skipped allows a user to skip the element and proceed directly to the code after the code for the element to be skipped.

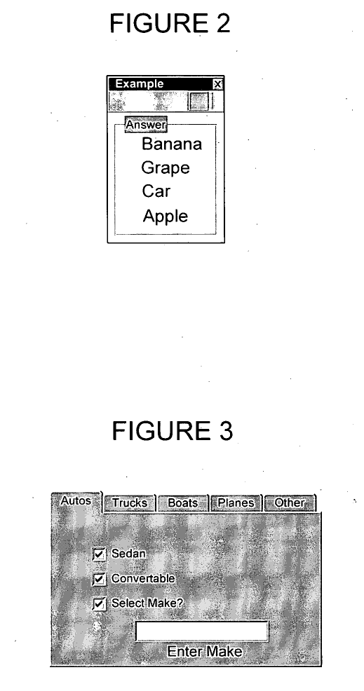

A groupbox is a type of box that may be used on Web pages. Elements inside a groupbox align themselves according to the rules of the box. FIG. 2 is an example of a simple groupbox. The code used to generate the groupbox shown in FIG. 2 is:

<groupbox>

<caption label=”Answer”/>
<description value=”Banana”/>
<description value=”Grape”/>
<description value=”Car”/>
<description value=”Apple”/>

</groupbox>

If this groupbox were being used on a Web page frequently visited by vision impaired users, Javascript may be provided allowing these users to skip the groupbox if they desire. However, with Javascript disabled, a vision impaired user utilizing, for example, a screen reader is unable to skip over the groupbox and is required to listen to information in the groupbox.

HTML includes an A tag with a HREF (Hypertext Reference) attribute that allows HTML developers to create links to other pages. According to various embodiments of the present disclosure, HREF coding blocks are added to various elements on a Web page allowing disabled users to skip those elements even when Javascript is disabled.

For example, according to an embodiment of the present disclosure, a HREF coding block can be provided to allow the user to skip a groupbox even if Javascript is disabled. An example of coding that can be added is:

<%

// The pre-amble to the group

%>
<%

String grpTxt = Webutil . translate(pageContext, <Group BOX Header Text Key>, null);
if (ui.isAccessible)
{

%>

| <a | href=”#group-end” |
|---|---|
| | id=”group-begin” |
| | title=“<isa:translate key=“access.grp.begin” arg0=“<%=grpTxt%>”/>”></a> |

<%

} //if (ui.isAccessible)

%>

The above code is entered at the beginning of the groupbox coding to insert an A tag with a HREF attribute at the beginning of the groupbox.

The groupbox code is then entered using the following conventions:

<%

// The group header code, as per the look and feel of the
application.

%>
<%

// The UI within the group, as per the application.

%>
<%

// The group termination code, as per the look and feel of the
application.

%>

The post-amble of the groupbox is then coded as follows to mark the end of the group:

<%

// The post-amble to the group

%>
<%

if (ui.isAccessible)
{

%>

| <a | href=”#group-begin” |
|---|---|
| | id=“group-end” |
| | title=”<isa:translate key=“access.grp.end” arg0=“<%=grpTxt%>” />” |
| | > |

</a>
<%

} //if (ui.isAccessible)

%>

Accordingly, coding is used to insert the A tag with the HREF attribute at the beginning of the groupbox. When the assistive technology is used to read the screen, it will read the header of the group announcing the groupbox beginning. By issuing a skip request (e.g., by pressing “ENTER” at this time or otherwise indicating to traverse the link), the user can follow the link to the end of the group specified by the post-amble of the group as shown above.

According to another embodiment of the present disclosure, a HREF coding block can be provided to allow the user to skip a tab control even if Javascript is disabled. FIG. 3 is an example of a simple tab control that may be provided on a Web page. Tab controls are often used on a web page to get a lot of material into a small space in a highly organized manner. The following code inserts an A tag with an HREF attribute to allow the tab control to be skipped by a user utilizing assistive technologies if the user so desires. An example of the coding that can be added is:

<%

// The pre-amble to the tab control

%>
<%

String tabTxt = WebUtil.translate(pageContext, <Tab Header Key>,
null);
if (ui.isAccessible)
{

int tabItems = <Number of the Tab Pages>;
String strTabItems = Integer.toString (tabItems);

%>

| <a | href=“#tab-end” id=”tab-begin” |
|---|---|
| | title= <isa:translate key=“access.tab.begin” arg0=“<%tabTxt%>” |

arg1=“<%=strTabItems%>“/>” >

</a>
<%

} //if (ui.isAccessible)

%>

The above code is entered at the beginning of the tab control coding to insert an A tag with an HREF attribute at the beginning of the tab control.

The Tab code is then entered using the following conventions:

<%

String tabItemTxt = WebUtil.translate(pageContext, tabButton.getText( ), null);
String unavailableTxt = WebUtil.translate(pageContext, “access.unavailable”, null);
String index = <Index of the current Page>;

%>
<%

/*

Whichever way you render the tab is OK, however, for the selected tab the title of
the tab element should have the following:

title=”<isa:translate key=”access.tab.selected” arg0=”<%=tabItemTxt%>”
arg1=”<%=Integer.toString(index)%>”
arg2=”<%=strTabItems%>”
arg3=”<%=unavailableTxt%>”

For the unselected page (tab), the title of the tab element should have the following:

title=”<isa:translate key=”access.tab.unselected”
arg0=”<%=tabItemTxt%>”
arg1=”<%=Integer.toString(index)%>”
arg2=”<%=strTabItems %>”
arg3=“”

*/

%>

The post-amble of the tab control is then coded as follows:

| <% | |
|---|---|
| | // The post pre-amble to the tab control |
| %> | |
| <% | |
| | if (ui.isAccessible) |
| | { |
| %> | |
| <a | href=“#tab-begin” |

id=“tab-end”
title=“<isa:translate key=“access.tab.end”
arg0=“<%=tabTxt%>“/>” >

</a>
<%

} //if (ui.isAccessible)

%>

The above code inserts an A tag with an HREF attribute at the beginning of the tab control. When assistive technology is used to read the screen, it will read the header of the tab control announcing the tab control beginning. By pressing “ENTER” at this time, the user can follow the link to the end of the tab control specified by the post-amble of the tab control as shown above.

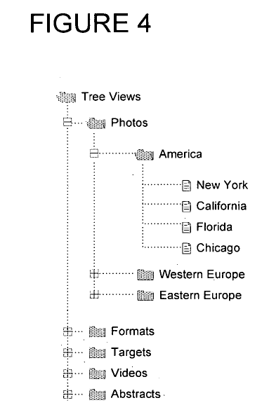

FIG. 4 is an example of a simple tree control that may be provided on a Web page. A tree control is another way or organizing material into a small space in a highly organized manner. Branches of the tree can be selected and expanded or contracted as desired to view various types of information that may be located in different files. According to another embodiment of the present disclosure, an HREF coding block can be provided to allow the user to skip a tree control even if Javascript is disabled. The following code inserts an A tag with an HREF attribute to allow the tree control to be skipped by a user utilizing assistive technologies if the user so desires. An example of the coding that can be added is:

<%

// The pre-amble to the tree control

%>

| <% | String treeTxt = WebUtil.translate(pageContext, <Tree Header |
|---|---|
| | Text>, null); |
| | if (ul.isAccessible) |
| | { |

%>

| <a | href=”#tree-end” |
|---|---|
| | id=”tree-begin” |
| | title=“=”<isa:translate key=“access.tree.begin” |
| | arg0=”<%=treeTxt%>“/>”> |

</a>
<%

} //if (ui.isAccessible)

%>

The above code is entered at the beginning of the tree control coding to insert an A tag with an HREF attribute at the beginning of the tree control.

The tree control is then coded using the following conventions:

<%

int nodelevel = <Node Level>;

/*

For an open node, the title of the node should have the following:

title=”<isa:translate key=“access.tree.open”
arg0=”<%=Integer.toString(nodelevel)%>”/>

For a closed node, the title of the node should have the following:

title=”<isa:translate key=”access.tree.closed”
arg0=”<%=Integer.toString(nodelevel)%>”/>”>

For a leaf node, the title of the node should have the following:

title=”<isa:translate key=“access.tree.leaf”
arg0=”<%=Integer.toString(nodelevel)%>”/>”>

The current node (if shown by visual means) needs to have the following:

title=”<isa:translate key=”access.tree.selected” arg0=”<Visible alternative text for

the node>”/>

If the current node is shown by visual means (for example bold), then the not current
nodes, need to have the following:

title=”<isa:translate key=“access.tree.unselected”/>

*/

%>

The post-amble of the tree is then coded as follows:

<%

// The post-amble to the tree

%>
<%

if (ui.isAccessible)
{

%>

| <a | href=“#tree-begin” |
|---|---|
| | id=“tree-end” |
| | title=“<isa:translate key=“access.tree.end” arg0=“<%=treeTxt%>“/>” |
| | > |

</a>
<%

} //if (ui.isAccessible)

%>

The above code inserts an A tag with an HREF attribute at the beginning of the tree control. When assistive technology is used to read the screen, it will read the header of the tree control announcing the tab control beginning. By pressing “ENTER” at this time, the user can follow the link to the end of the tree control specified by the post-amble of the tree control as shown above.

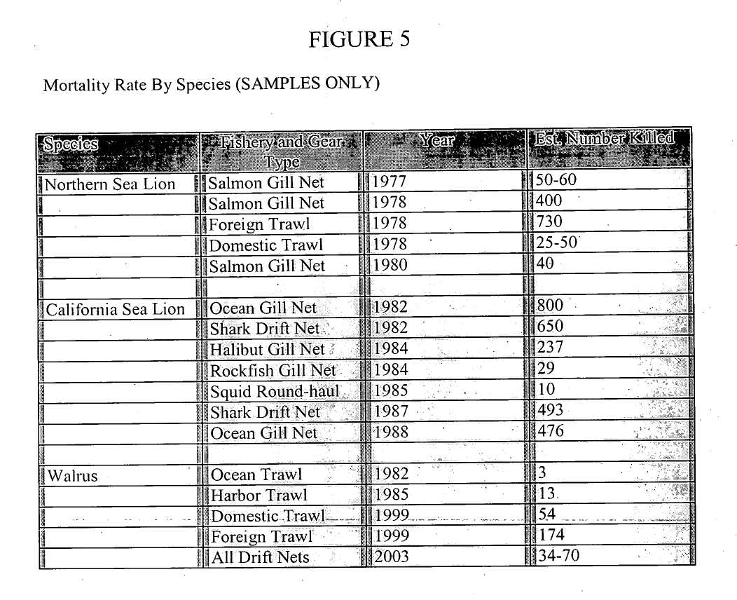

FIG. 5 is an example of a simple data table that may be provided on a Web page. A data table is often used to lay out information in a logical format which makes it easier for a user to readily understand the information. According to another embodiment of the present disclosure, a HREF coding block can be provided to allow the user to skip a data table even if Javascript is disabled. The following code inserts an A tag with an HREF attribute to allow the data table to be skipped by a user utilizing assistive technologies if the user so desires. The following code example may be used for simple data tables (e.g., one column is not split, etc.) Of course, more complex tables can be coded utilizing the techniques described in the present disclosure. An example of the coding that can be added is:

<%

/*

Data table preamble

%>
<%

int colno = <Number of columns>;
int rowno = <Number of rows>;
String columnNumber = Integer.toString(colno);
String rowNumber = Integer.toString(rowno);
String firstRow = Integer.toString(<First Row shown>);
String lastRow = Integer.toString(<Last Row shown>);
String tableTitle = WebUtil.translate(pageContext, <Table Title
Key>, null);

%>
<%

if (ui.isAccessible)
{

%>

| <a | href=“#tableend” |
|---|---|
| | id=“tablebegin” |
| | title = ”<isa:translate key=“access.table.begin” |

arg0=“<%=tableTitle%>”
arg1=“<%=rowNumber%>”
arg2=“<%=columnNumber%>”
arg3=“<%=firstRow%>”
arg4=“<%=lastRow%>”/>”

>

</a>
<%

}

%>
<%

/*

Data table preamble ends

*/

%>

The above code is entered at the beginning of the data table coding to insert an A tag with an HREF attribute at the beginning of the data table.

The table code is then entered utilizing the following conventions. The table uses a header that has a summary attribute filled as:

Summary=“<isa:translate key = “access.table.summary” arg0=“<%=tableTitle%>” arg1=“<%=firstRow%>”
arg2=“<%=columnNumber%>” arg3=“<%=firstRow%>” arg 4=“<%=lastRow%>“/>”

The table will also utilize a table header from a template, the following of which is an example:

<tr>

<th id=“<Column 1 Id>” scope=“col” title=”<isa:translate

key=“<Column 1 Header Key>” />”>
<isa:translate key=“<Column 1 Header Key>”/></th>

<th id=“<Column 2 Id>” scope=“col” title=”<isa:translate

key=“<Column 2 Header Key>” />”>
<isa:translate key=“<Column 2 Header Key>”/></th>

</tr>

For each cell, this needs to be bound to the column headers as:

<tr>

<td headers=“<Column 1 id>”> <Your Data> </td>
<td headers=“<Column 2 id>”> <Your Data> </td>

</tr>

The post-amble of the table is then coded as follows:

| <% | |
|---|---|
| | // Data Table Postamble |
| | if (ui.isAccessible) |
| | { |
| %> | |
| <a | id=“tableend” |

href=“#tablebegin”
title = “<isa:translate key= “access.table.end”
arg0=“<Table Name>”/>”>

</a>
<%

} // if (ui.isAccessible)

%>

The above code inserts the A tag with the HREF attribute at the beginning of the data table. When assistive technology is used to read the screen, it will read the header of the data table announcing the data table beginning. By pressing “ENTER” at this time, the user can follow the link to the end of the data table specified by the post-amble of the data table as shown above.

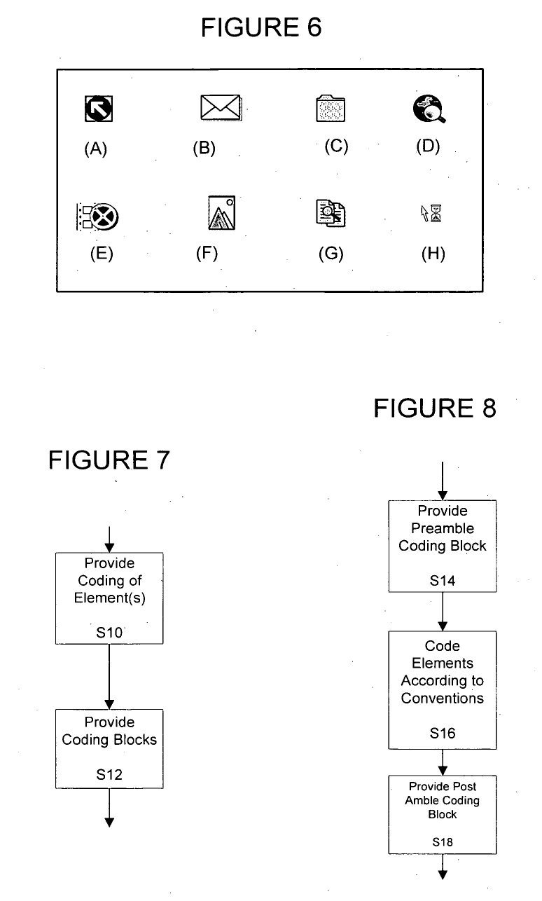

FIG. 6 are examples of various types of push buttons that may be provided on a Web page. Push buttons are used to select links to other sites or files. Button (A) provides a link to a Microsoft FrontPage element. Button (B) is an Internet email link. Button (C) is used to provide a link to a file. Button (D) is a search control link. Button (E) is a link to a video file. Button (F) provides a link to a graphics file. Button (G) provides a link to a resource on a Gopher server. Using a mouse, a user moves a cursor as shown in FIG. 6(H) over the button to select it. According to another embodiment of the present disclosure, a HREF coding block can be provided to allow the user to skip a push button even if Javascript is disabled. The following code inserts an A tag with an HREF attribute to allow the push button to be skipped by a user utilizing assistive technologies if the user so desires.

For an input type button or for a button tag, a title addition should be done as follows:

<%

String backBtnTxt = WebUtil.translate(pageContext,
“catalog.isa backToQuery”, null);

%>
<input type=“button”

class= “FancyButtonGrey”
title=“<isa:translate

key=“access.button”
arg0=“<%=backBtnTxt%>”
arg1 =”“/>”
value=”<isa:translate
key=”catalog.isa.backToQuery“/>”

onClick=“” >

Arg1 in the text for “access.button” above specifies if the button is “unavailable” or “”.

For a link or any other rendering mechanism of a button, the code writer should make sure that the title is used with the right text, as shown by the following example:

| | |
|---|---|
| <a | href=“#” |

onclick=“startLogin(‘<%UserActions.PN_LOGIN%>’

‘<isa:translate key=“um.clc.login.jsp.login”/>’),”

title=“<Use the access button title here>”
class=“button”
name=“<%=UserActions.PN_LOGIN%>”

>

<isa:translate key=“um.clc.login.jsp.login”/>

</a>

FIG. 7 is a flow chart for describing overall embodiments of the present disclosure. According to these embodiments, code is provided for elements on a Web page (Step S10). The code is in a mark-up language such as, for example, HTML, XHTML, etc. Coding blocks are then provided allowing disabled users to skip the elements on the Web page (Step S12). The coding blocks are also in a mark-up language such as, for example, HTML, XHTML, etc.

FIG. 8 is a flow chart for further describing Step S12 shown in FIG. 7. A coding block of a preamble of the code for an element on the Web page is provided (Step S14). The preamble inserts an A tag with an HREF attribute (an HREF block) at the beginning of the element. The code for the element on the Web page is chosen using set conventions (Step S16). A post amble coding block is then provided at the end of the code for the element on the Web page, to add an anchor (Step S14). A disabled user utilizing assistive technology can skip elements on the Web page coded according to embodiments of the present disclosure and go directly to the anchor by selecting ENTER at the appropriate time, even if scripts are disabled on the user's browser.

Embodiments of the present disclosure have been described with respect to specific Web page elements. Of course, the disclosure is not limited to those elements. In addition, although the various embodiments have been described utilizing HTML, it will be appreciated that aspects of the present disclosure may be applied to other mark-up languages as well as any technology that generates HTML, including but not limited to HTMLB, other tag libraries, etc.

To provide for interaction with a user, the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The present system can be implemented in a computing system that includes a back-end component, e.g., as a data server, or that includes a middle-ware component, e.g., an application server, or that includes a front-end component, e.g., a client computer having a graphical interface or a Web browser through which a user can interact with an implementation of the present disclosure, or any combination of such back-end, middleware, or front-end components. The components of the computing system can be interconnected by any form or medium of digital data communication, e.g., a communication network. Examples of communication networks include a local area network (“LAN”) and a wide area network (“WAN”), e.g., the Internet.

The computing system can include clients, servers and service-oriented processes (implemented, for example, using conventional web services). Distributed computing approaches and service-oriented architectures typically interact through a communication network. The relationship of client and server arises by virtue of computer programs running on respective computers and having a client-server relationship to each other.

The present system has been described in terms of particular embodiments. Other embodiments are within the scope of the following claims. For example, although the present system has been described as a component in a larger system, it can also be implemented in other systems or as a stand-alone system.

Numerous additional modifications and variations of the present disclosure are possible in view of the above-teachings. It is therefore to be understood that within the scope of the appended claims, the present disclosure may be practiced other than as specifically described herein. For example, elements and/or features of different illustrative embodiments may be combined with each other and/or substituted for each other within the scope of this disclosure and appended claims.

What is claimed is:

1. A method of coding a Web page for improving accessibility for a disabled user using assistive technology to read the Web page, comprising:
coding a first element on a Web page; and
modifying the first element to include at least one coding block in a language not effected by a scripting control setting on a browser used to display the Web page and configured to skip the first element responsive to receiving a skip request from the disabled user.

2. The method of claim 1, wherein the first element on the Web page comprises at least one of a groupbox, tab control, tree control, data table view and a push button.

3. The method of claim 1, wherein the first element and the at least one coding block are coded in a mark-up language.

4. The method of claim 1, wherein the at least one coding block comprises a tag that is placed prior to a beginning of the coding of the first element on the Web page.

5. The method of claim 4, wherein the at least one coding block further comprises an anchor placed at an end of the coding of the first element on the Web page, and wherein the tag allows users of the Web page to jump to the anchor if so desired.

6. The method of claim 5, wherein the tag comprises an A tag with an HREF attribute.

7. The method of claim 1, wherein the scripting control setting on the browser used to display the Web page disables scripts.

8. A system of providing a Web page with improved accessibility for a disabled user using assistive technology to read the web page, comprising:
preparing code describing the Web page, the code including,
a) code for displaying a first element of the Web page,
b) code modifying the first element to include at least one coding block in a language not effected by a scripting control setting on a browser used to display the web page and configured to skip the first element responsive to receiving a skip request from the disabled user; and
making the code describing the Web page available to users.

9. The system of claim 8, wherein the first element on the Web page comprises at least one of a groupbox, tab control, tree control, data table view and a push button.

10. The system of claim 8, wherein the code for displaying the first element and the at least one coding block are coded in a mark-up language.

11. The system of claim 8, wherein the at least one coding block comprises a tag that is placed prior to a beginning of the code of the element on the Web page.

12. The system of claim 11, wherein the at least one coding block further comprises an anchor placed at an end of the code of the first element on the Web page, and wherein the tag allows users of the Web page to jump to the anchor if so desired.

13. The system of claim 12, wherein the tag comprises an A tag with an HREF attribute.

14. The system of claim 8, wherein the scripting control setting on the browser used to display the Web page disables scripts.

15. A computer recording medium including computer executable code for improving accessibility for a disabled user using assistive technology to read a Web page, comprising:
code for displaying a first element on a Web page; and
code modifying the first element to include at least one coding block in a language not effected by a scripting control setting on a browser used to display the Web page and configured to skip the first element responsive to receiving a skip request from the disabled user.

16. The computer recording medium of claim 15, wherein the first element on the Web page comprises at least one of a groupbox, tab control, tree control, data table view and a push button.

17. The computer recording medium of claim 15, wherein the first element and the at least one coding block are coded in a mark-up language.

18. The computer recording medium of claim 15, wherein the at least one coding block comprises a tag that is placed prior to a beginning of the coding of the first element on the Web page.

19. The computer recording medium of claim 18, wherein the at least one coding block further comprises an anchor placed at an end of the coding of the first element on the Web page, and wherein the tag allows users of the Web page to jump to the anchor if so desired.

20. The computer recording medium of claim 19, wherein the tag comprises an A tag with an HREF attribute.

21. The computer recording medium of claim 15, wherein the scripting control setting on the browser used to display the Web page disables scripts.

22. A computer data signal transmitted in one or more segments in a transmission medium which embodies code for displaying a Web page on a computer, the Web page for improving accessibility for a disabled user using assistive technology to read the Web page, comprising:
code for displaying a first element on a Web page; and
code modifying the first element to include at least one coding block in a language not effected by a scripting control setting on a browser used to display the Web page and configured to skip the first element responsive to receiving a skip request from the disabled user.
